(19) United States
(12) Patent Application Publication
(10) Pub. No.: US 2026/0266067 A1
(43) Pub. Date: Sep. 10, 2026

(54) LIGHTWEIGHT ALUMINUM UNITIZED SCAFFOLDING FRAME

(71) Applicant: Elia Bahou, Burlington (CA)

(72) Inventor: Elia Bahou, Burlington (CA)

(21) Appl. No.: 19/166,463

(22) PCT Filed: Mar. 21, 2023
(86) PCT No.: PCT/CA2023/050367

§ 371 Date: Sep. 17, 2025

(51) Int. Cl. E04G 1/14; A62B 35/00; E04G 5/02; E04G 5/10; E04G 5/16; E04G 7/02; E04G 11/48; E04G 25/02

(52) U.S. Cl. CPC E04G 1/14; A62B 35/0068; E04G 5/02; E04G 5/10; E04G 5/16; E04G 7/02; E04G 11/483; E04G 25/02

(57) ABSTRACT

A lightweight, aluminum unitized scaffolding structure to support an overhead load includes a frame with at least two vertical posts, at least two horizontal members mounted between the two vertical posts, a brace extending between the two vertical posts, an integrated ladder at one of the two vertical posts. The structure includes at least two screw jack feet attaching at the top of the posts, at least two screw jack heads attaching at the bottom of the posts, and a main beam attaching at the head. An anchor at a location near the integrated ladder provides a tie-off point for a worker's personal fall protection system.

### FIELD

The field of the invention is structures such as prefabricated or unitized scaffolding and shoring systems, in particular, frames used for assembling the structures.

### BACKGROUND OF THE INVENTION

The following description includes information that may be useful in understanding the present invention. It is not an admission that any of the information provided herein is prior art or relevant to the presently claimed invention, or that any publication specifically or implicitly referenced is prior art.

Scaffolding construction involves erecting temporary structures that are used to support workers and materials during construction or maintenance work, and in shoring systems as a temporary measure to provide support to the structure of a building. While scaffolding is essential for many construction projects, it also poses significant hazards to workers if it is not properly designed, erected, and maintained. Some of the hazards of scaffolding construction include: falls, collapse, falling objects, weather conditions, and improper installation.

Scaffolding for formwork is an essential component of construction projects, particularly in the building of concrete structures such as walls, columns, and slabs. The scaffolding provides support for the formwork, which in turn holds the concrete in place until it sets and hardens. Once the concrete has hardened, the formwork and scaffolding are removed, leaving the finished structure in place.

Conventional approaches to scaffolding construction involve: first installing the base or foundation of the scaffolding. This may involve placing base plates or adjustable feet on the ground and securing them with screws or bolts, Second, the vertical tubes, also known as standards, are then inserted into the base plates and secured using couplers or clamps. Third, horizontal tubes or ledgers are inserted into the couplers and secured using locking pins or clips. Fourth, diagonal braces are then installed to provide additional stability to the scaffolding. These are inserted between the standards and ledgers and secured using couplers.

Prefabricated scaffolding is a type of scaffolding that is manufactured off-site and delivered to the construction site for assembly. In larger construction projects, its use can be more efficient and cost-effective than traditional scaffolding. Prefabricated scaffolding is manufactured in a controlled environment, ensuring more consistent quality and reliability.

However, prior approaches to prefabricated scaffolding suffer from some disadvantages, including limited customization, higher cost, transportation and storage requirements, training involved for assembly and disassembly, and maintenance and repair.

The present invention is intended to address some of the hazards inherent in scaffolding construction and the disadvantages of existing prefabricated scaffolding solutions.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of features used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations, Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### BRIEF DESCRIPTION OF DRAWINGS

Various objects, features, aspects, and advantages of the inventive subject matter will become more apparent from the following detailed description of preferred embodiments, along with the accompanying drawing figures in which like numerals represent like components.

FIG. 1A is a perspective view of a unitized scaffolding frame in accordance with a first example of the present specification;

FIG. 1B is a perspective view of a unitized scaffolding frame in accordance with a second example of the present specification;

FIG. 2 is a front view of the unitized scaffolding frame of FIG. 1A;

FIG. 3 is a front view of the unitized scaffolding frame of FIG. 1A;

FIG. 4 is a left side view of the unitized scaffolding frame of FIG. 1A;

FIG. 5 is a right side view of the unitized scaffolding frame of FIG. 1A;

FIG. 6 is a top plan view of the unitized scaffolding frame of FIG. 1A;

FIG. 7 is a bottom plan view of the unitized scaffolding frame of FIG. 1A;

FIG. 8 is a cross-sectional view of a first frame portion given by the line 8-8 in FIG. 2;

FIG. 9 is a cross-sectional view of a second frame portion given by the line 9-9 in FIG. 2;

FIG. 10 is a cross-sectional view of a third frame portion given by the line 10-10 in FIG. 2;

FIG. 11 is a perspective view of two unitized scaffolding frames of FIG. 1A, shown with connectors and heads and feet:

FIG. 12 is a front view of a scaffolding structure using the scaffolding frames of FIG. 1A, in accordance with an example of the present specification; and

FIG. 13 is a side view of a scaffolding structure using the scaffolding frames of FIG. 1A, shown in an operating environment.

### DETAILED DESCRIPTION OF THE INVENTION

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second”, “third” and other such numerical terms referring to structures do not imply a sequence or order unless clearly indicated by the context.

A scaffolding structure is a temporary framework made up of interconnected components that is used to support workers, tools, and materials during construction, maintenance, or repair of buildings or other structures. Scaffolding structures typically provide a safe and stable platform for workers to access different parts of the building or structure, such as walls, ceilings, roofs, and windows. Scaffolding structures can vary in size, shape, and complexity depending on the type and scale of the construction project.

Shoring scaffolding is a specialized system of framework that provides stability and support for heavy loads, enabling work crews to perform tasks safely and securely. This type of scaffolding is specifically designed for situations where the load is situated directly overhead. Unlike traditional scaffolding, which primarily serves to provide access to elevated areas, shoring scaffolding is capable of bearing significant weight loads that surpass the capacities of standard scaffolding. As a result, it serves as a robust temporary or semi-permanent structure for heavy-duty projects,
While shoring scaffolding is primarily utilized to provide support for various building components such as edifices, ceilings, or networks of beams, it can also serve a secondary purpose of granting access to work areas. This is achieved by incorporating decks and rails, which provide similar access options to those of traditional access scaffolding. Shoring scaffolding finds application across many sectors of the construction industry, and can be combined with a variety of pillar systems to offer additional support.

Properly designed and installed scaffolding for formwork is critical to ensuring the safety of construction workers, as well as the quality of the finished product. Scaffolding must be able to support the weight of the formwork, concrete, and workers, and it must be erected and dismantled in a safe and controlled manner.

One example of a scaffolding structure to support an overhead load according to the present specification includes a structure with a number of lightweight aluminum frames, each frame including two vertical posts, two horizontal members mounted between the two vertical posts, a brace extending between the two vertical posts, an integrated ladder at one of the two vertical posts. The structure also includes at least two screw jack feet attaching at the top of the posts, at least two screw jack heads attaching at the bottom of the posts, and a main beam attaching at the head. An anchor at a location near the integrated ladder provides a tie-off point for a worker's personal fall protection system.

In the context of the present specification, “frame” refers to a unitized or pre-engineered unit or module that serves as a building block of the scaffolding structure. The frame is designed to provide support and stability to the scaffolding structure and to facilitate easy assembly and disassembly. Generally speaking, frames can come in different shapes and sizes, such as square, or rectangular, depending on the specific requirements of the scaffolding project. They can also be made from different materials, such as steel, aluminum, or composite materials, to meet the demands of different construction environments and conditions. The term “unitized” refers to a process or system in which various components are prefabricated or assembled into pre-made units or modules, which can be joined together to form a larger structure or system. This method of construction can offer several benefits, including faster construction times, improved quality control, and reduced on-site labour costs.

Aluminum frames offer several advantages over other materials for use in prefabricated scaffolding, including: aluminum is a lightweight material, which makes it easy to handle and transport. This means that scaffolding made from aluminum frames can be assembled and dismantled quickly; aluminum is resistant to corrosion, which makes it suitable for use in outdoor construction sites and other harsh environments. This also means that scaffolding made from aluminum frames is durable and can last a long time without needing repairs or replacement; despite its lightweight nature, aluminum is a strong and durable material that can support heavy loads. Scaffolding made from aluminum frames can withstand the weight of workers, tools, and materials without bending or breaking; aluminum frames can be easily customized and adapted to different scaffolding configurations, making them versatile and suitable for a wide range of construction projects; aluminum frames generally require less maintenance compared to other materials like steel. They do not rust or corrode, which reduces the need for regular cleaning, painting, or repairs.

In one example, the frames may be made of T6 6061 aluminum. This refers to a specific type of aluminum alloy that is commonly used in the manufacturing of structural and mechanical components, such as bike frames, aircraft parts, and automotive parts. The T6 designation refers to the heat treatment process used to harden the aluminum, which involves heating it to a specific temperature and then quenching it in water to cool it rapidly. This process results in an alloy that is stronger and more durable than untreated aluminum. 6061 aluminum is an alloy composed of aluminum, magnesium, and silicon, with trace amounts of other elements. It is known for its high strength-to-weight ratio, excellent machinability, resistance to corrosion, and versatility.

Advantageously, scaffolding structures, according to examples described in the present specification, are designed to accommodate the demands of construction projects that involve non-uniform floor heights and elevated mezzanine levels. These structures are modular in nature and can be stacked using frames to provide a versatile and adaptable solution for such projects.

One notable attribute of scaffolding structures, according to examples described in the present specification, is the inclusion of an integrated ladder system that enables workers to access an intermediate frame assembly during construction and/or working platform with ease. Additionally, the frames can be equipped with integrated tie-off points that serve as secure anchorage points for fall arrest systems, further ensuring worker safety.

As well, a telescopic platform beam feature of the scaffolding structures facilitates width adjustment and enables the creation of a stable working platform for workers. According to one example, the platform beam can extend from 1.10 to 1.55 m, 1.50 m to 2.25 m, and 2.25 to 3.65 m.

With a frame width of 1.50 m, frames can be made compatible with both traditional loose top construction using materials such as aluminum or wood beams, as well as with modular decking systems like Skydeck™ or Ultradek™. Modular decking refers to a type of prefabricated decking system that is designed to be used as a surface for concrete formwork. It is made up of a series of interlocking panels that can be assembled to create a flat, stable surface for pouring concrete. Modular decking can be made from high-strength materials such as aluminum, steel or plastic, which makes it durable and resistant to damage from the weight of concrete and other construction materials. It can be used to create a variety of formwork shapes and sizes, including straight, curved, and circular formwork. The use of modular decking for formwork is advantageous in that it saves time and labour by reducing the need for custom-made formwork, Secondly, it provides a consistent, level surface for concrete pouring, resulting in a smooth, even finish. Additionally, the modular design allows for easy installation and dismantling, which reduces construction time and costs.

Frames according to examples of the present specification have been subjected to testing in compliance with CSA S269.2-16 8.2 standards, which encompassed tower tests at varying heights of 1.2 m and 1.8 m, involving one-tier, two-tier, and three-tier configurations, Advantageously, such frames can provide a lightweight alternative to steel shoring systems and feature a leg load capacity of 70 kN (16 kips), The use of lightweight aluminum frames makes it easier to handle; it is approximately one-third less in weight in comparison to alternative steel frames.

The advantages of using a unitized system are numerous. Prefabricated scaffolding can be assembled quickly and efficiently, reducing labour costs and increasing productivity. The lightweight design of the frame makes it easy to move and transport. The frames can be arranged on a storage pallet to make an efficient use of space and reducing storage requirements and costs.

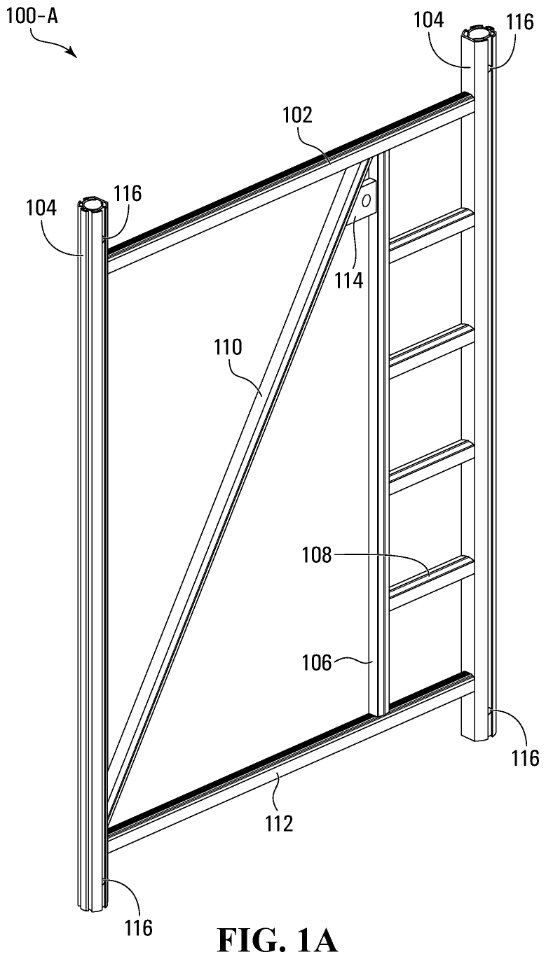

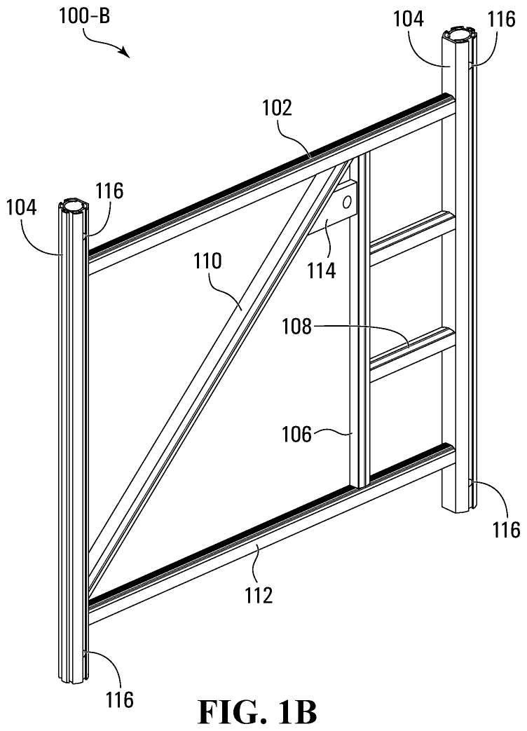

FIG. 1A illustrates a frame 100-A for use in a scaffolding or shoring system in accordance with an example of the present specification. As shown in FIG. 1A, frame 100-A includes two posts 104 (also referred to as legs, standards, uprights, verticals, and poles) interconnected by two horizontal members 102 and 112 (also referred to as ledgers, transoms, bearers, runners). A cross brace 110 provides reinforcement to the frame 100-A. An integrated ladder is made up of an interior vertical member 106 spanning between the upper horizontal member 102 and the lower horizontal member 112 with a number of interior rungs 108; four interior rungs are shown in FIG. 1A. An integrated anchor 114 provides a tie-off point for a worker's fall arrest system (also referred to as a personal fall protection system). A personal fall protection system is a safety system designed to protect workers from falling from heights. It typically includes a harness or body belt that is worn by the worker and connected to a lifeline or anchor point using a lanyard or similar device. The system is designed to arrest a worker's fall and prevent them from hitting the ground or other hazards below. Personal fall protection systems are commonly used in construction, maintenance, and other industries where workers are required to work at heights.

Still with reference to FIG. 1A, the posts 104 include a number of pin holes 116 to secure scaffold components together using pins, bolts, or other fasteners. Pin holes allow for quick and easy assembly and disassembly of scaffold structures, as the pins or bolts can be inserted through the holes to hold the components in place.

The skilled reader will appreciate that variations to the frame of FIG. 1A are possible and intended to be within the scope of the present specification, such as the position and orientation of the cross-brace 110, the size and width of the integrated ladder, the size and width of the frame 100-A, and the size, position and number of horizontal members 102 and 112 and/or vertical posts 104. In the example of FIG. 1A, the height of the frame 100-A is 1.80 m, while the height of the frame 100-B (shown in FIG. 1B) is 1.20 m. The frame 100-B has two interior rungs 108. In one example, the frame 100-a weighs about 22.20 kg compared to over 35 kg for a comparable steel frame.

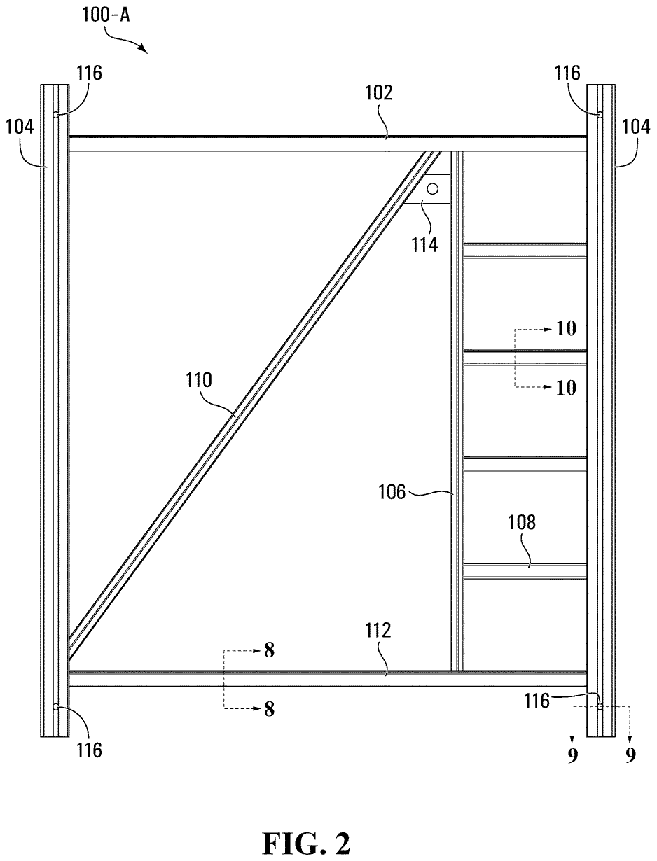

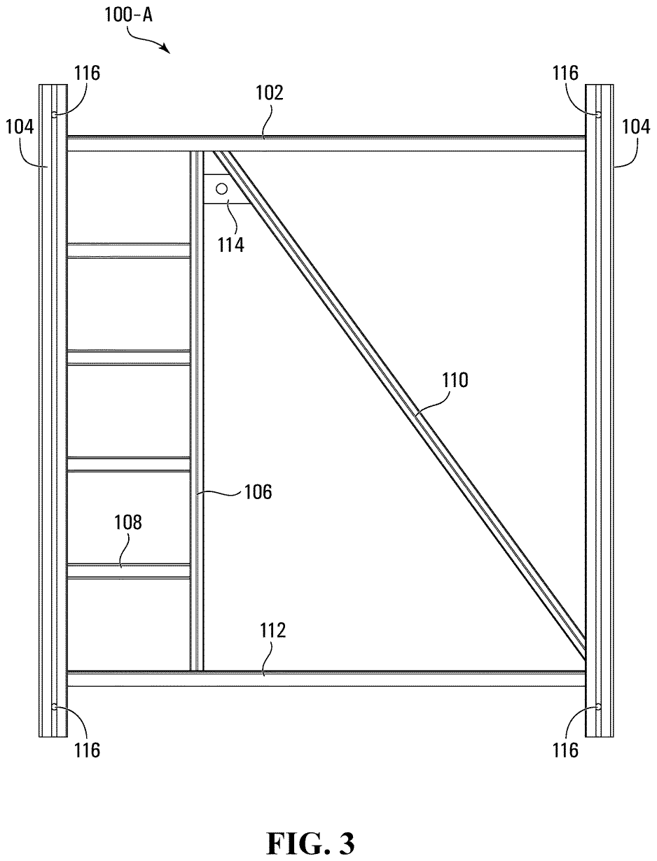

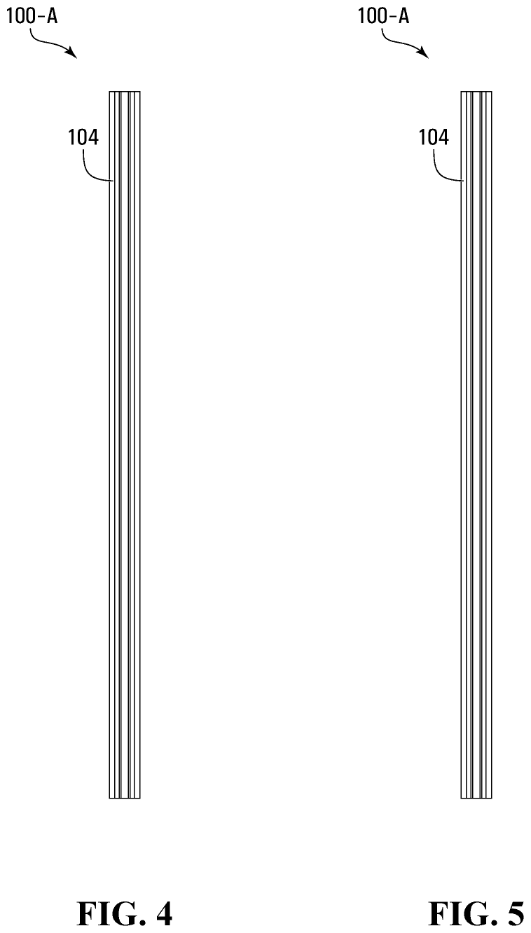

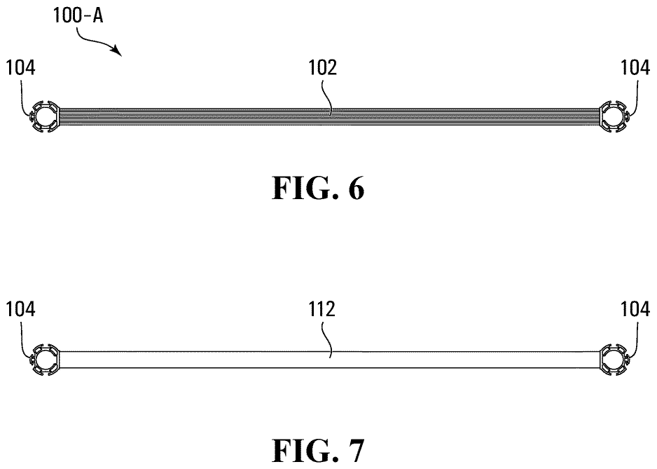

FIG. 2 to FIG. 7 provide additional views of frame 100-A. FIG. 2 and FIG. 3 show more clearly the orientation of cross-brace 110 that connects one of the posts 104 to the upper horizontal member 102. As well, FIG. 2 illustrates that the anchor 114 connects the cross-brace 110 to the ladder post 106. The result is a highly rigid frame that that when made of aluminum is intended to withstand stress and weight loads comparable to the performance of steel, which is typically known to provide a higher yield strength and tensile strength at the cost of being heavier in terms of weight.

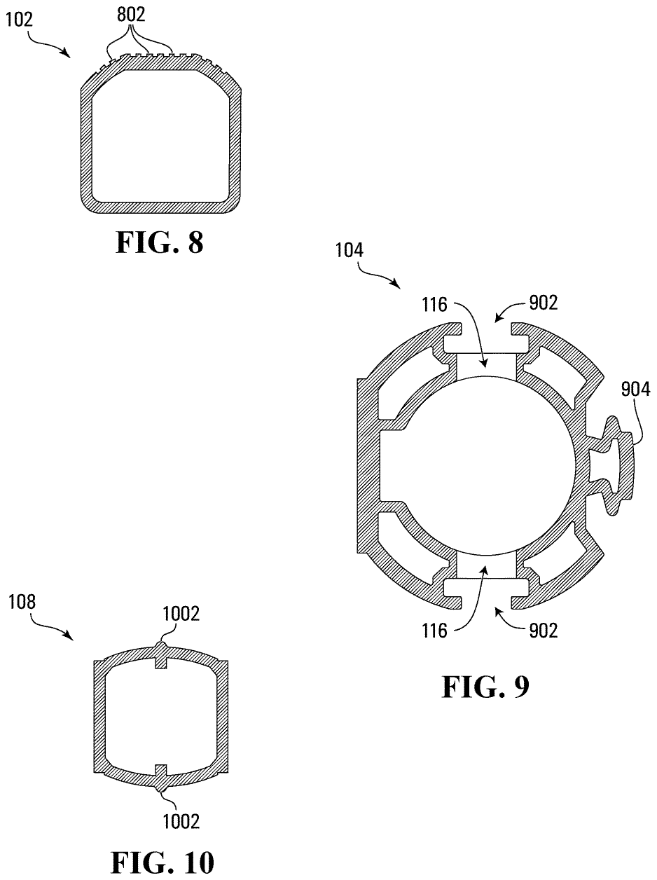

Turning to FIG. 8 and FIG. 9, horizontal cross-sections of various members of frame 100-A are shown. FIG. 8 shows the cross-section of horizontal members 102 and 112. In this example, the horizontal member 102 is shaped to resist being crushed and furthermore the surface has a “slip-resistant” or “anti-slip” feature designed to provide increased traction and prevent slips or falls, particularly in wet or slippery conditions. In cross-section, the horizontal member 102 has a perforated pattern with raised portions identified by the reference character 802. Similarly, the cross-section of ladder rung 108 shown in FIG. 9 has a raised portion 1002 for slip-resistance as well as an interior rib portion for added strength. The slip-resistant surface can be enhanced by using textured coatings.

Now with reference to FIG. 10, a vertical cross-section of posts 104 is shown. In this example, the post 104 is shaped with features of a tongue 904 and/or grooves 902 to accommodate clamping or connection with other scaffolding equipment.

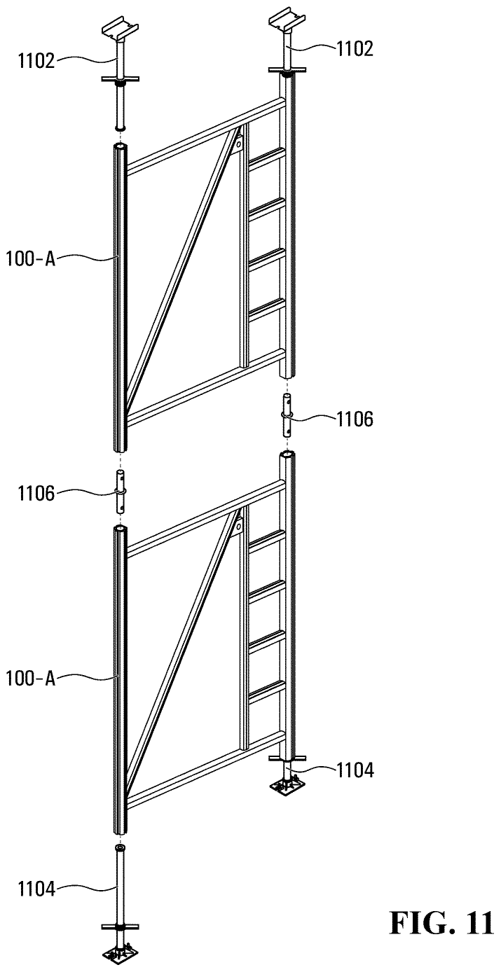

FIG. 11 illustrates a frame assembly of two frames 100-A interposed with connectors 1106. The frame assembly terminates in screw jack heads 1102 at the top and screw jack feet 1104 at the bottom. Pins that insert into pin holes 116 as well as holes in the connectors 1106 and/or screw jack foot 1104 and/or screw jack heads 1102 are not shown in FIG. 11. The screw jack heads 1102 have an upper portion that is U-shaped to support a primary beam, which acts as a base for the concrete formwork decking. The purpose of the screw jack heads 1102 is to provide a level and stable support for the main beam (not shown in FIG. 11) upon which the decking or other structural elements are laid. The U-shaped design of the screw jack heads 1102 allows them to securely grip the main beam and hold it in place, while also allowing for adjustments in height as needed to ensure that the beam is level. The purpose of the screw jack feet 1104 is to provide a stable base for the overall structure by distributing the weight of the structure evenly over the supporting surface. The screw jack feet 1104 are adjustable, which means they can be raised or lowered to level the structure on uneven ground or to adjust the height of the structure as needed. In one example, the allowable jack extension length (including stripping relief) is about 30 cm measured from the top of baseplate to the end of the frame.

By using screw jack heads 1104 and screw jack feet 1104, it is possible to provide a stable and level foundation for the structure, which is important for ensuring its safety and stability over time. Additionally, the adjustability of the screw jack heads 1102 and screw jack feet 1104 allows for flexibility in the construction process, making it easier to achieve the desired height and levelness for the overall structure. The screw jack heads 1102 and screw jack feet 1104 can be made from metal, such as aluminum, with a threaded shaft that can be adjusted to the required height, Variations of the supports at the top and/or bottom of the frame assembly are contemplated and intended to be included in the scope of the present specification. For example, adjustable steel props, hydraulic jacks, wood cribbing, and other alternatives can be used to support loads and/or provide leveling adjustments.

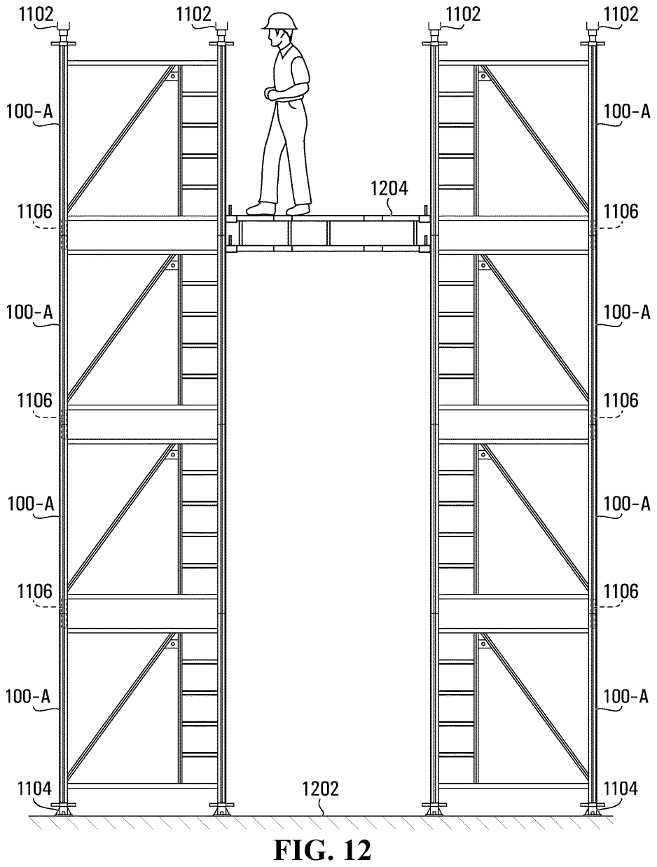

FIG. 12 is a schematic illustration of a scaffolding structure made up of two frame assemblies on top of a floor 1202, each frame assembly comprising a height of four frames 100-A. A platform 1204 is clamped to the posts of opposing posts 104.

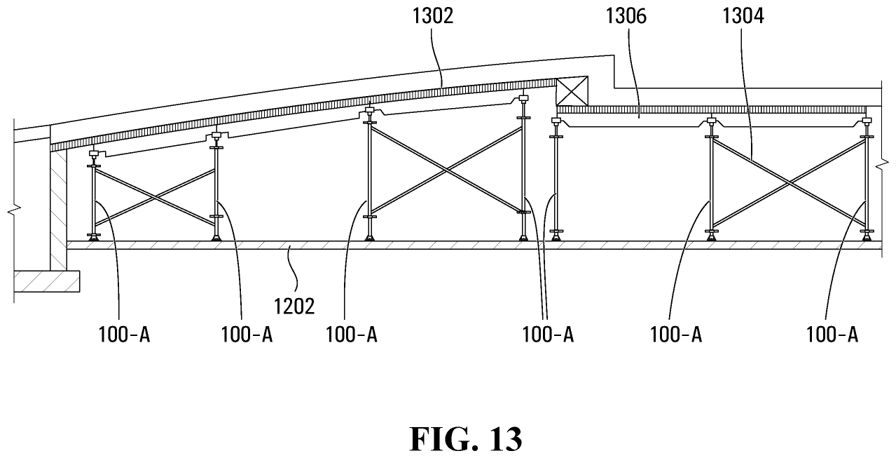

FIG. 13 is a side view of an exemplary shoring scaffolding system with seven frame assemblies shown in profile, each frame assembly made up of one or more frames 100-A. Diagonal bracing 1304 is shown which serves to reinforce the network or matrix. It will be appreciated that the decking 1302 could be uneven or slanted, and examples of the present specification illustrate that the modular aspect of the system provides a convenient way to build a scaffolding structure including beams 1306.

Samples of the scaffolding structures according to examples of the present specification were subjected to load testing according to the requirements of the GSA (Canadian Standards Association). The test is generally outlined in section 8.2 of the CSA S269.2-16 standard and involved subjecting each sample to a constant load rate, measured in pounds per minute, with the load rate falling between 5,000 lbs/min and 10,000 lbs/min. The load was applied directly to load-bearing members using hydraulic jacks until the sample failed or load refusal occurred. A minimum of three samples was required for each post shore size/span, and the testing protocol required that the deviation from the average should not be greater than 10% if the deviation was greater than 10%, additional samples would be required to ensure accuracy. The test was designed to determine the load capacity and failure point of a sample, and to ensure that the sample met the standards set forth by the GSA. The testing was conducted with a robust load frame that had four hydraulic rams and a pressure transducer. A single servo-hydraulic testing system was used to apply the load through the four hydraulic rams. The tests were regulated using a control program based on LabVIEW™ and an RMC75™ servo-controller. The samples, comprising two frames per tier, four screw jack feet, four screw jack heads, and diagonal bracing connecting the frames, were arranged vertically beneath a support beam assembly at the top of the assembly, and each of the screw jack feet was placed directly on top of the hydraulic rams, A steady rate of load was applied until either the system reached its maximum output or the sample failed. Throughout each test, load information was continuously recorded at a frequency of 10 Hz. For one tier, as well as two and three tiers of the 1.20 m frame, the test indicated a maximum load per leg (kips) of greater than 40, reaching the maximum output of the testing system. For two tiers of the 1.80 m frame, the test indicated a maximum load per leg (kips) of greater than 40. For three tiers of the 1.80 m frame, the test indicated an average maximum load per leg (kips) 35 or greater. A kip is a unit of force commonly used to express loads. One kip is equal to 1,000 pounds-force (lbf). A safety factor was applied to achieve a maximum permissible vertical leg load of 16 kips (70 KN) per leg in three-tier tower systems using frames sized 1.20 m or 1.80 m. The tests were conducted at screw jack extensions of 30 cm.

In a typical installation, unitized scaffolding frames are assembled into a scaffolding structure by connecting them using diagonal braces and other components. The process of assembling a scaffolding structure from unitized scaffolding frames can be performed horizontally or in an upright fashion. In the upright fashion, assembly typically involves the following steps: the screw jack feet or base is set up first. Next, the first level of unitized scaffolding frames is then installed on top of the base. The unitized scaffolding frames are typically connected together using horizontal diagonal braces to provide stability. Then, additional levels of unitized frames are then added on top of the first level, using vertical posts to connect the frames together. With the horizontal or standard assembly, the tower, or at least a number of lower tiers, are assembled horizontally and then hoisted into place either manually or using a forklift or shifting device. Then, additional levels of unitized frames are then added on top of the lower level(s), using vertical posts to connect the frames together. Advantageously, workers can tie off at the anchor points at each level and use the integrated ladder to climb the structure. For safety, workers are instructed to climb on the inside of the assembly or tower. Moreover, guardrails (not shown in the drawings) can be installed around the edges of each level to provide fall protection for workers. Other components such as planks and access gates are then installed to provide access and support for workers, After a tower has been placed back on its side, it can be dismantled in reverse order.

Use of aluminum for the frames refers to a frame that is constructed using aluminum alloy material and is designed to be as light as possible while still being strong and durable enough to support the weight of workers, tools, and materials. Aluminum frames benefit from corrosion resistance and low maintenance requirements, making them a good choice in harsh or outdoor environments. In the context of scaffolding systems, frames are designed to reduce weight as much as possible without compromising load-bearing capacity or structural integrity, resulting in a more manageable and easy-to-handle scaffolding system compared to traditional steel systems.

The manufacturing process for unitized scaffolding frames according to the present specification can vary, but welding is one method used in their fabrication. Unitized scaffolding frames according to examples of the present specification may be made from aluminum tubing that is cut to length, shaped, and welded together to create the desired frame structure. The welding process involves joining the metal tubes at the joints, using specialized welding equipment to ensure a strong and durable bond. Other types of fabrication is intended to be within the scope of the present specification. In addition to welding, other manufacturing techniques may be used, such as bending, stamping, or pressing the metal tubing into the desired shape, and then connecting the pieces together using bolts, rivets, or other fasteners.

Advantageously, scaffolding shoring structure of the present specification provides a versatile scaffolding system that can be used for various applications such as below-grade levels with loose top construction or Skydeck™ Ultradek™, mezzanine levels with high floors (e.g., five or more), corners/slab steps/balcony areas to support truss tables above, drop beams, and column capitals. For high floors, there can be a material saving in labour and materials.

The present specification discloses an example of a scaffolding structure or assembly with one or more unitized scaffolding frames. The unitized scaffolding frame includes at least two vertical posts. The frame also includes at least two horizontal members mounted between the two vertical posts. The frame also includes a brace extending between the two vertical posts and an integrated ladder at one of the two vertical posts. The assembly includes at least two screw jack feet for attaching at the top of the posts. The assembly also includes at least two screw jack head for attaching at the bottom of the posts. The assembly also includes a main beam for attaching at the two screw jack heads. The unitized scaffolding frame is made of lightweight aluminum.

Implementations may include one or more of the following features. The unitized scaffolding frame further may include an anchor at a location proximate the integrated ladder providing a tie-off point for a worker's personal fall protection system. The vertical posts of the unitized scaffolding frame have a cross-section that may include a front groove, a rear groove, and a side tongue for inter-connection with other scaffold equipment. The aluminum may be 6061 T6 aluminum. The leg load capacity of the frame may be about 70 kn (16 kips). The frame may be about 1.20 m in height and about 1.50 m in width. Alternatively, the frame may be about 1.80 m in height or about 2.40 m in height. The scaffolding structure may include a concrete formwork decking on top of the main beam. The two screw jack feet may attach at the bottom of the posts of a lowermost frame; and the two screw jack heads may attach at the top of the posts of an uppermost frame. A first integrated ladder from one of the unitized scaffolding frames in the assembly cooperates with a second integrated ladder from another of the unitized scaffolding frames above or below the first integrated ladder to form a continuous ladder. The assemblies may be spaced apart horizontally, and supported by a horizontal bracing. Decking may be installed between the first main beam and the second main beam.

One general aspect includes a method for constructing a scaffolding structure to support an overhead load. The method includes receiving a plurality of unitized scaffolding frames. The method also includes installing a first screw jack foot and a second screw jack foot at bottom locations of a first of the plurality of unitized scaffolding frames to form a first intermediate assembly. The method also includes installing a third screw jack foot and a fourth screw jack foot at bottom locations of a second of the plurality of unitized scaffolding frames to form a second intermediate assembly that is spaced apart from the first intermediate assembly in a substantially parallel orientation. The method also includes installing a bracing between the first intermediate assembly and the second intermediate assembly, the bracing being substantially perpendicular to the first intermediate assembly and the second intermediate assembly. The method also includes connecting additional of the plurality of frames to the first and second intermediate assemblies using connectors in a vertical direction, where an integrated ladder portion of each of the frames extends to form a continuous ladder for climbing each intermediate assembly, and where an integrated anchor of the each of the frames provides a tie-off point to accommodate a worker's personal fall protection system when installing said additional frames. The method also includes when a first top is reached, installing a first screw jack head and a second screw jack head at top locations of the first intermediate assembly. The method also includes when a second top is reached, installing a third screw jack head and a fourth screw jack head at top locations of the second intermediate assembly. The method also includes installing a first main beam on top of the first screw jack head and the second screw jack head. The method also includes installing a second main beam on top of the third screw jack head and the fourth screw jack head. The method also includes adjusting one or more of the screw jack feet, and one or more of the screw jack heads for a tight fit.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements or components may be present, or utilized, or combined with other elements, components, or steps that are not expressly referenced.

1. A scaffolding structure to support an overhead load comprising:
a unitized scaffolding frame comprising:
at least two vertical posts;
at least two horizontal members mounted between the two vertical posts;
a brace extending between the two vertical posts;
an integrated ladder at one of the two vertical posts;
at least two screw jack feet for attaching at the top of the posts;
at least two screw jack head for attaching at the bottom of the posts; and
a main beam for attaching at the two screw jack heads;
wherein the unitized scaffolding frame comprises aluminum.

2. The scaffolding structure according to claim 1 wherein the unitized scaffolding frame further comprises an anchor at a location proximate the integrated ladder providing a tie-off point for a worker's personal fall protection system.

3. The scaffolding structure according to claim 2 wherein the vertical posts of the unitized scaffolding frame have a cross-section comprising a front groove, a rear groove, and a side tongue for inter-connection with other scaffold equipment.

4. The scaffolding structure according to claim 1 wherein the aluminum comprises 6061 T6 aluminum.

5. The scaffolding structure according to claim 4 wherein a leg load capacity of the frame is about 70 kN (16 kips).

6. The scaffolding structure according to claim 5 wherein the frame is about 1, 2 m in height.

7. The scaffolding structure according to claim 5 wherein the frame is about 1.80 m in height.

8. The scaffolding structure according to claim 4 wherein the frame is about 2.40 m in height.

9. The scaffolding structure according to any one of claims 6, 7, and 8 wherein the frame is about 1.50 m in width.

10. The scaffolding structure according to claim 9 further comprising:
a concrete formwork decking on top of the main beam.

11. The scaffolding structure according to claim 1 comprising an assembly of unitized scaffolding frames arranged vertically between one or more connectors, wherein the two screw jack feet attach at the bottom of the posts of a lowermost frame; and wherein the two screw jack heads attach at the top of the posts of an uppermost frame.

12. The scaffolding structure according to claim 11 wherein a first integrated ladder from one of the unitized scaffolding frames in the assembly cooperates with a second integrated ladder from another of the unitized scaffolding frames above or below the first integrated ladder to form a continuous ladder.

13. A scaffolding system comprising a plurality of the scaffolding structures of claim 11 for supporting a building, wherein the assemblies are spaced apart horizontally, and supported by a horizontal bracing.

14. A method for constructing a scaffolding structure to support an overhead load comprising the steps of:
receiving a plurality of unitized scaffolding frames comprising aluminum;
installing a first screw jack foot and a second screw jack foot at bottom locations of a first of the plurality of unitized scaffolding frames to form a first intermediate assembly;
installing a third screw jack foot and a fourth screw jack foot at bottom locations of a second of the plurality of unitized scaffolding frames to form a second intermediate assembly that is spaced apart from the first intermediate assembly in a substantially parallel orientation;
installing a bracing between the first intermediate assembly and the second intermediate assembly, the bracing being substantially perpendicular to the first intermediate assembly and the second intermediate assembly;
connecting additional of the plurality of frames to the first and second intermediate assemblies using connectors in a vertical direction, wherein an integrated ladder portion of each of the frames extends to form a continuous ladder for climbing each intermediate assembly, and wherein an integrated anchor of the each of the frames provides a tie-off point to accommodate a worker's personal fall protection system when installing said additional frames;
when a first top is reached, installing a first screw jack head and a second screw jack head at top locations of the first intermediate assembly;
when a second top is reached, installing a third screw jack head and a fourth screw jack head at top locations of the second intermediate assembly;
installing a first main beam on top of the first screw jack head and the second screw jack head;
installing a second main beam on top of the third screw jack head and the fourth screw jack head;
adjusting one or more of the screw jack feet, and one or more of the screw jack heads for a tight fit.

15. The method for constructing a scaffolding structure according to claim 14 further comprising installing concrete formwork decking between the first main beam and the second main beam.

16. A unitized scaffolding frame comprising:
at least two vertical posts;
at least two horizontal members mounted between the two vertical posts;
a brace extending between the two vertical posts;
an integrated ladder at one of the two vertical posts; and
an anchor at a location proximate the integrated ladder providing a tie-off point for a worker's personal fall protection system.
